(19) United States
(12) Patent Application Publication
(10) Pub. No.: US 2025/0188897 A1
(43) Pub. Date: Jun. 12, 2025

(54) AIR INTAKE SYSTEM

(71) Applicant: North American Assembly, LLC, Auburn Hills, MI (US)

(72) Inventors: Thomas Richard Schaenzer, Oxford, MI (US); Thomas Wayne Weeks, Almont, MI (US); Aaron Matthew Hutyra, Ortonville, MI (US); Edward Graham Johnson, Sterling HJeights, MI (US); Peter John Rittersdorf, Lake Orion, MI (US)

(73) Assignee: North American Assembly, LLC, Auburn Hills, MI (US)

(21) Appl. No.: 18/971,116

(22) Filed: Dec. 6, 2024

Related U.S. Application Data
(60) Provisional application No. 63/606,913, filed on Dec. 6, 2023.

(51) Int. Cl. F02M 35/02; F02M 35/10

(52) U.S. Cl. CPC F02M 35/021; F02M 35/10013

(57) ABSTRACT

An air intake system for an internal combustion engine of a vehicle includes a main housing defining an interior chamber configured to receive an air filter, a cover seated on the main housing to enclose the air filter within the interior chamber, dual intake ducts fluidly coupled to the interior chamber and configured to provide cold intake air directly from a high pressure zone behind a vehicle grille, an air outlet formed in the main housing and configured to receive intake air that has passed through the air filter, and an air intake duct having a first end coupled to the air outlet and a second end configured to couple to a throttle body of the engine. The air intake system is configured to provide a short airflow path directly into the engine rather than through a tortuous path.

### CROSS REFERENCE TO RELATED APPLICATION

This application claims the benefit of U.S. Provisional App. No. 63/606,913, filed on Dec. 6, 2023, the contents of which are incorporated herein by reference thereto.

### FIELD

The present application relates generally to vehicles and, more particularly, to an air intake system for an internal combustion engine of a vehicle.

### BACKGROUND

Internal combustion engines include air intake systems to provide intake air to cylinders for combustion with fuel. However, conventional air intake systems often include many ducts and components that form a complex tortuous path that results in restrictions and reduced airflow. While such systems work well for their intended purpose, it is desirable to provide continuous improvement in the relevant art to provide greater utility.

### SUMMARY

In accordance with one example aspect of the invention, an air intake system for an internal combustion engine of a vehicle is provided. In an example implementation, the air intake system includes a main housing defining an interior chamber configured to receive an air filter, a cover seated on the main housing to enclose the air filter within the interior chamber, dual intake ducts fluidly coupled to the interior chamber and configured to provide cold intake air directly from a high pressure zone behind a vehicle grille, an air outlet formed in the main housing and configured to receive intake air that has passed through the air filter, and an air intake duct having a first end coupled to the air outlet and a second end configured to couple to a throttle body of the engine. The air intake system is configured to provide a short airflow path directly into the engine rather than through a tortuous path.

In addition to the foregoing, the described vehicle system may include one or more of the following features: wherein the air intake duct includes an elbow, wherein the elbow is the only elbow in the air intake system between the dual intake ducts and the throttle body; wherein the elbow provides a turn in the airflow path that is approximately 90°; wherein the air filter is generally annular and the cover is a generally circular plate; wherein the air intake duct includes a mass air flow (MAF) tube coupled to the main housing air outlet, and a throttle body duct coupled to the MAF tube and configured to couple to the throttle body; wherein the MAF tube includes a MAF sensor; a MAF wiring jumper electrically coupled to the MAF sensor; and a make-up air (MUA) tube fluidly coupled to the MAF tube and configured to provide make-up air thereto.

In addition to the foregoing, the described vehicle system may include one or more of the following features: wherein the main housing includes a bottom wall and a generally annular sidewall that define the interior chamber with a generally cylindrical shape; one or more rear attachment flanges extending outwardly from the main housing sidewall and including at least one first aperture configured to receive a first fastener for coupling to an engine compartment of the vehicle, and one or more front attachment flanges extending outwardly from the dual intake ducts and including at least one second aperture configured to receive a second fastener for coupling to the engine compartment; a hydrocarbon absorber pad disposed on the bottom wall within the interior chamber; and wherein the main housing sidewall includes a cutout located between the dual intake ducts, and wherein the cutout is configured to receive a removable window.

In addition to the foregoing, the described vehicle system may include one or more of the following features: wherein the air outlet is formed through the bottom wall; wherein each of the dual intake ducts includes a top wall, a bottom wall, and a pair of opposed sidewalls extending between the top wall and the bottom wall, wherein the top wall, bottom wall, and opposed sidewalls define a port for providing intake air to the main housing interior chamber; wherein the top wall and opposed sidewalls are integrated with the main housing, and wherein the bottom wall is removably attached to the opposed sidewalls; and a kit comprising the previously described air intake system, wherein the kit is configured to replace a conventional air intake system of a vehicle.

In accordance with another example aspect of the invention, a vehicle is provided. In one example, the vehicle includes an internal combustion engine having a throttle body configured to receive intake air, an engine compartment with a grille, and an air intake system. The air intake system includes a main housing defining an interior chamber configured to receive an air filter, a cover seated on the main housing to enclose the air filter within the interior chamber, dual intake ducts fluidly coupled to the interior chamber and configured to provide cold intake air directly from a high pressure zone behind the grille, an air outlet formed in the main housing and configured to receive intake air that has passed through the air filter, and an air intake duct having a first end coupled to the air outlet and a second end configured to couple to the throttle body. The air intake system is configured to provide a short airflow path directly into the engine rather than through a tortuous path.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the essence of the present disclosure are intended to be within the scope of the present disclosure.

### BRIEF DESCRIPTION OF THE DRAWINGS

FIG. 1 is a top perspective view of an example air intake system in accordance with the principles of the present disclosure;

FIG. 2 is a bottom perspective view of the example air intake system shown in FIG. 1, in accordance with the principles of the present disclosure;

FIG. 3 is a front view of the example air intake system shown in FIG. 1, in accordance with the principles of the present disclosure; and

FIG. 4 is an exploded view of the example air intake system of FIG. 1, before assembly, in accordance with the principles of the present disclosure.

### DESCRIPTION

As previously discussed, vehicle internal combustion engines typically include an air intake system to provide intake air to cylinders for combustion with fuel. However, conventional air intake systems often include many ducts and components that form a complex tortuous path that results in restrictions and reduced airflow. Accordingly, described herein are systems and methods for an air intake system configured to guide ram air directly into the vehicle engine to increase engine performance. This direct air injection forgoes the need for standard complex tortuous airflow paths. In some embodiments, the air intake system may be a kit designed to replace at least a portion of a conventional air intake system.

With reference now to the Figures, an example air intake system 10 for an internal combustion engine is illustrated in accordance with the principles of the present invention. In one example, the air intake system 10 is a kit that may be quickly and easily installed on an existing internal combustion engine. Tools are not required to service the filter, and the filter may be reusable, cleanable and does not require oiling. The air intake system 10 is a short runner cold air intake tuned to increase torque and horsepower. Thus, the system does not require the long ducts, tubes, and boxes of conventional systems. The system may be manufactured using injection molded premium materials and includes optimized flow. Moreover, the system is validated for mass air flow (MAF) sensor compatibility and thus does not trigger check engine lights.

In the example embodiment, the air intake system 10 provides a true cold air intake, with the intake air source being directly from the high-pressure zone behind the grill. Advantageously, the air intake system 10 does not have engine compartment air inlets that suck in hot air. In some examples, the air intake system 10 may be made from glass filled nylon. The air intake system 10 may also have non-linear restriction characteristics to improve engine torque. As such, in some examples, the air intake system 10 may provide a greater than 40% improved flow of cold air over conventional systems with less restriction. Further, the air intake system 10 may include a large plenum volume (e.g., nine liters) and support a large diameter air filter (e.g., 16 inches). Additionally, in some embodiments, the air intake system 10 advantageously only includes one elbow into the throttle body. As such, the air intake system 10 described herein is a ram air system that provides a short and optimized airflow path directly into the engine rather than through a tortuous path.

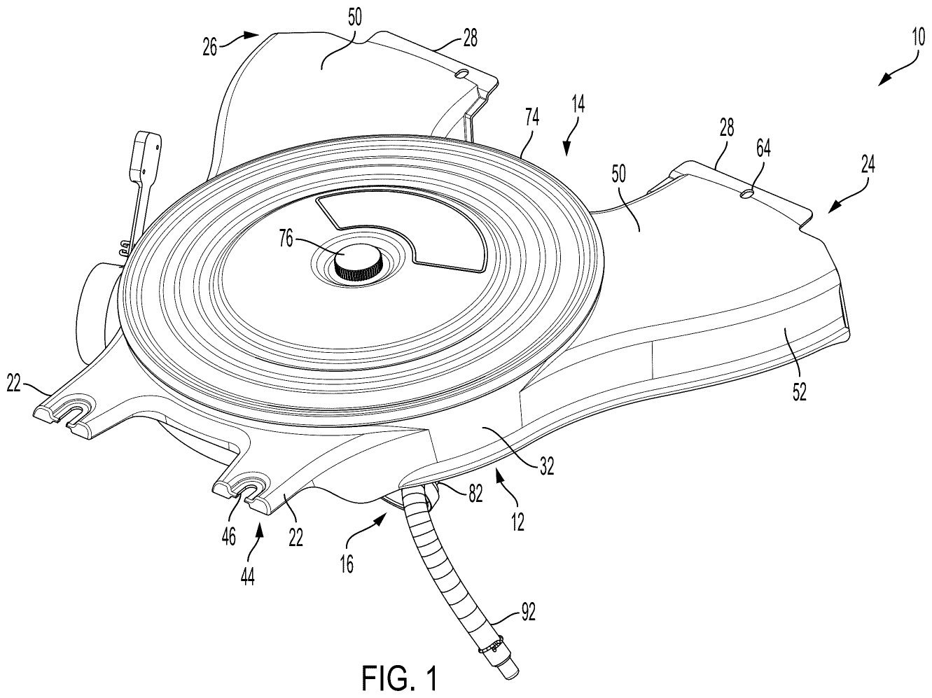

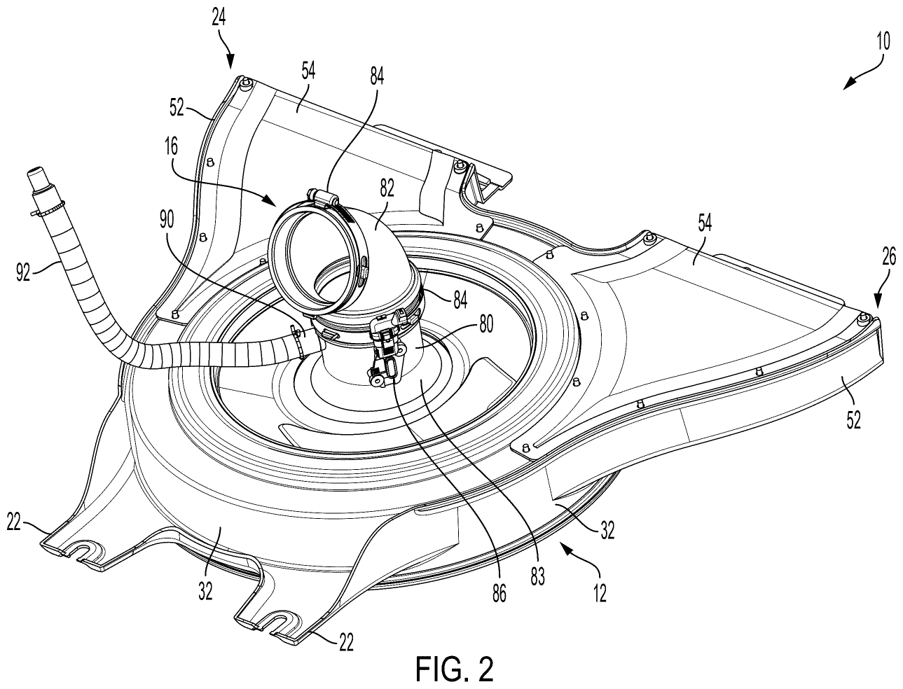

With reference now to FIGS. 1-4, the air intake system 10 will be described in more detail. In the example embodiment, the air intake system 10 generally includes a main body or housing 12, an air filter assembly 14, and an intake duct assembly 16.

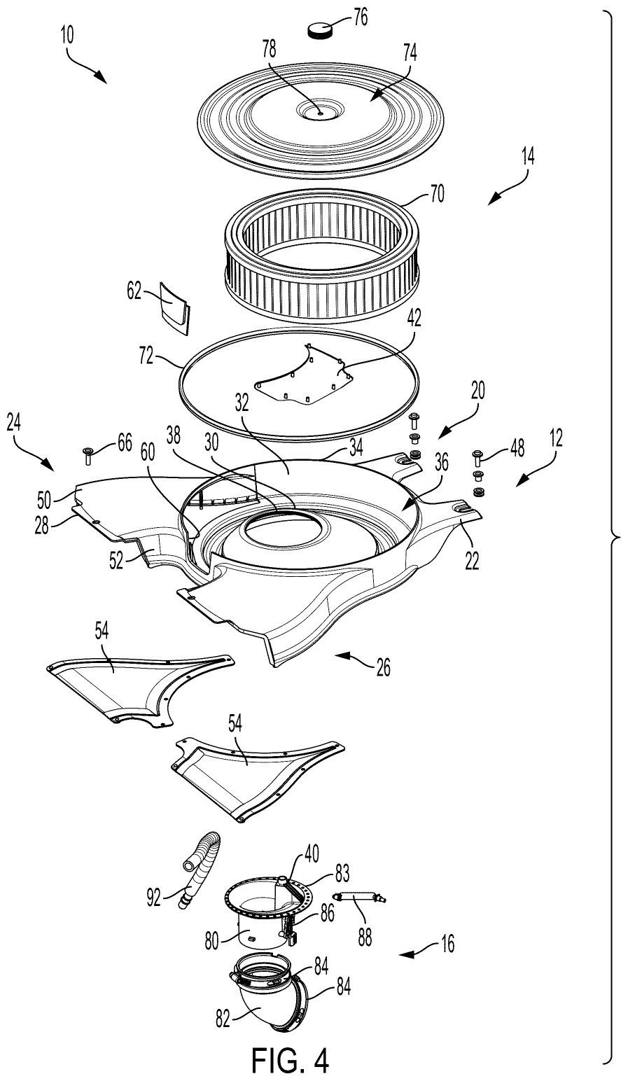

With particular reference now to FIG. 4, the main housing 12 generally includes an air filter housing 20, one or more rear attachment flanges 22, a pair of intake ducts 24, 26, and one or more front attachment flanges 28. The air filter housing 20 includes a bottom wall or filter seat 30, a sidewall 32, and an upper sealing edge 34 that define a generally cylindrical interior chamber 36 configured to at least partially receive the air filter assembly 14. The bottom wall 30 defines an outlet port 38 configured to fluidly couple to the intake duct assembly 16. An attachment member 40 extends upwardly from the bottom wall 30 and/or outlet port 38 and is configured to facilitate coupling of the air filter assembly 14 to the main housing 12, as described herein in more detail. In some embodiments, a hydrocarbon absorber pad 42 is integrated with or coupled to the bottom wall 30 (e.g., via fasteners, adhesive, etc.).

In the example embodiment, the sidewall 32 has an annular or generally annular shape configured to receive an annular air filter. However, it will be appreciated that sidewall 32 may have any suitable shape. As shown, the sidewall 32 is substantially contiguous except for areas connecting to the intake ducts 24, 26 to allow intake air into the interior chamber 36. In the example implementation, a pair of rear attachment flanges 22 are integrated with and extend outwardly from the sidewall 32. Each rear attachment flange 22 includes a distal end 44 with an aperture 46 configured to receive a fastener 48 for coupling the main housing 12 to a component within the engine compartment (not shown). However, it will be appreciated that main housing 12 may include any suitable number of rear attachment flanges 22 (e.g., one, three, etc.).

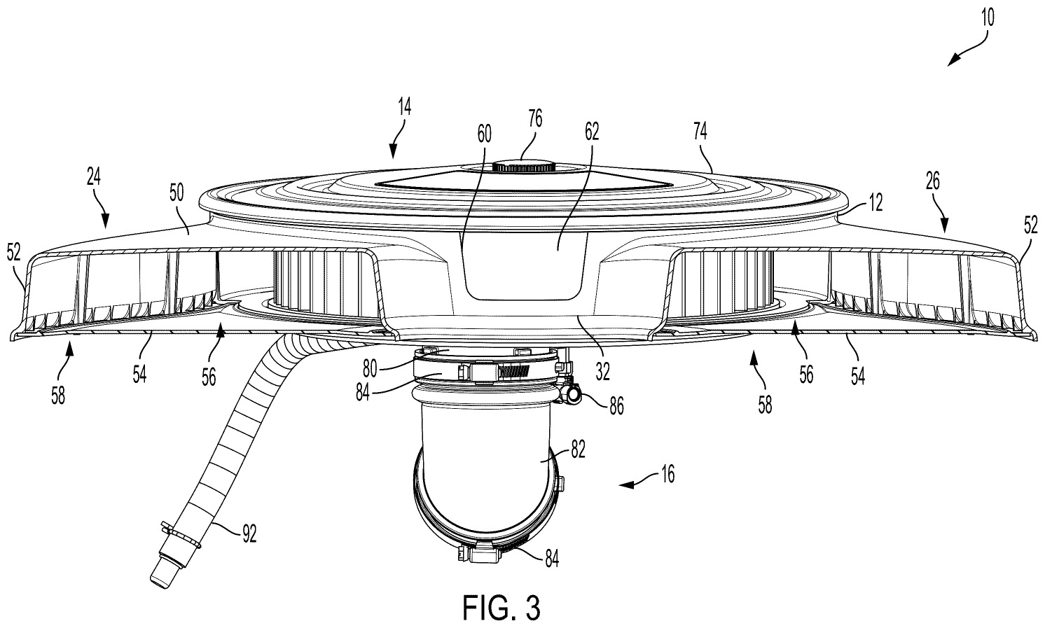

In the example implementation, the intake ducts 24, 26 are integrated with and extend outwardly from the sidewall 32 toward a front of the vehicle. Each intake duct 24, 26 includes a top wall 50, a pair of opposed sidewalls 52, and a bottom wall 54, which form a port 56 with a generally rectangular cross-section for providing ram intake air to the main housing interior chamber 36. As shown in FIG. 3, each intake duct 24, 26 includes a ram air inlet 58, which is configured to be disposed behind a vehicle front grille (not shown) to receive the ram intake air. In one example, the bottom walls 54 are separate covers, which are subsequently coupled to the opposed sidewalls 52 to enclose the port 56. In this way, ram air is able to enter through either air inlet 58 and travel through two separate ports 56 to deliver a maximum amount of flow to the interior chamber 36 and into intake duct assembly 16. While two intake ducts 24, 26 are shown, it will be appreciated that alternative designs may include any suitable number of intake ducts (e.g., one, three, etc.).

Additionally, the main housing sidewall 32 can include a cutout 60 between the intake ducts 24, 26. The cutout 60 is configured to receive a window 62, which enables viewing into the interior chamber 36, for example, to view a condition of interior components. The one or more front attachment flanges 28 are integrated with and extend outwardly from the intake ducts 24, 26 (e.g., the top walls 50). The front attachment flange(s) 28 include one or more apertures 64 configured to receive a fastener 66 for coupling to a component within the engine compartment (e.g., radiator, grille, etc.), to thereby secure the air intake system 10 within the engine compartment.

In the example embodiment, the air filter assembly 14 generally includes an air filter 70, a seal 72, an air filter lid or cover 74, and a fastener 76. The air filter 70 is configured to be inserted into the main housing interior chamber 36 and seat upon the bottom wall 30. The seal 72 (e.g., O-ring) is coupled to the main housing upper sealing edge 34. The air filter cover 74 is a generally circular plate configured to seat on the seal 72 to thereby enclose the air filter 70 within the main housing interior chamber 36. The air filter cover 74 includes a centrally located aperture 78 configured to receive the fastener 76 therethrough for coupling to the attachment member 40 located within the interior chamber 36. In this way, the air filter cover 74 is securely attached to the main housing 12 in a fluid tight sealing arrangement with the seal 72. Advantageously, the fastener 76 may be unscrewed by hand in order to replace the air filter 70, thereby obviating the need for tools during servicing.

In the example embodiment, the intake duct assembly 16 generally includes a MAF tube 80 and throttle body duct 82. The MAF tube 80 is coupled to the outlet port 38 to receive filtered ram airflow therefrom. In some embodiments, the MAF tube 80 includes an annular flange 83 and is seated within the outlet port 38 from the interior chamber 36 such that annular flange 83 seats against bottom wall 30. In other embodiments, MAF tube 80 may be integrally formed with the main housing 12. In one example, the attachment member 40 may be integrated with the MAF tube 80 and extend upwardly from the annular flange 83, as shown in FIG. 4.

The throttle body duct 82 is coupled to the MAF tube 80 and is configured to directly couple to a throttle body of the engine (not shown). For example, a first clamp 84 couples a first end of the throttle body duct 82 to the MAF tube 80, and a second clamp 84 couples an opposite second end of the throttle body duct 82 to the throttle body. The clamps 84 may be separate components or integrated with the throttle body duct 82. Further, the throttle body duct 82 may be a flexible duct that enables easy coupling between the MAF tube 80 and the throttle body.

In the example implementation, the MAF tube 80 includes a MAF sensor 86 configured to monitor and measure airflow through the MAF tube 80. A MAF wiring jumper 88 is configured to electrically couple to the MAF sensor 86 to provide one or more signals from the MAF sensor 86 to a vehicle controller, such as an engine control unit (not shown). Additionally, the MAF tube 80 may include a port 90 for attachment to a make-up air (MUA) tube 92.

With continued reference to FIGS. 1-4, in an example operation, intake air is forced into the dual intake ducts 24, 26 through ports 56, which are located behind the vehicle grille. The intake air passes through the dual intake ducts 24, 26 and directly into the main housing interior chamber 36. The intake air then passes through air filter 70 and into the centrally located outlet port 38. The intake air may make a turn of approximately 90° from the interior chamber 36 into the outlet port 38. From there, the intake air is directed through the MAF tube 80 and the throttle body duct 82 directly into the engine throttle body. The intake air may make a turn of approximately 90° in the throttle body duct 82. In this way, intake air is forced directly into the engine with only limited turns through the outlet port 38 and intake duct assembly 16 to thereby reduce flow restriction and increase airflow, leading to increased engine power and torque.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the essence of the present disclosure are intended to be within the scope of the present disclosure.

What is claimed is:

1. An air intake system for an internal combustion engine of a vehicle, the air intake system comprising:
a main housing defining an interior chamber configured to receive an air filter;
a cover seated on the main housing to enclose the air filter within the interior chamber;
dual intake ducts fluidly coupled to the interior chamber and configured to provide cold intake air directly from a high pressure zone behind a vehicle grille;
an air outlet formed in the main housing and configured to receive intake air that has passed through the air filter; and
an air intake duct having a first end coupled to the air outlet and a second end configured to couple to a throttle body of the engine,
wherein the air intake system is configured to provide a short airflow path directly into the engine rather than through a tortuous path.

2. The air intake system of claim 1, wherein the air intake duct includes an elbow, wherein the elbow is the only elbow in the air intake system between the dual intake ducts and the throttle body.

3. The air intake system of claim 2, wherein the elbow provides a turn in the airflow path that is approximately 90°.

4. The air intake system of claim 1, wherein the air filter is generally annular and the cover is a generally circular plate.

5. The air intake system of claim 1, wherein the air intake duct comprises:
a mass air flow (MAF) tube coupled to the main housing air outlet; and
a throttle body duct coupled to the MAF tube and configured to couple to the throttle body.

6. The air intake system of claim 5, wherein the MAF tube includes a MAF sensor.

7. The air intake system of claim 6, further comprising a MAF wiring jumper electrically coupled to the MAF sensor.

8. The air intake system of claim 5, further comprising a make-up air (MUA) tube fluidly coupled to the MAF tube and configured to provide make-up air thereto.

9. The air intake system of claim 1, wherein the main housing includes a bottom wall and a generally annular sidewall that define the interior chamber with a generally cylindrical shape.

10. The air intake system of claim 9, further comprising:
one or more rear attachment flanges extending outwardly from the main housing sidewall and including at least one first aperture configured to receive a first fastener for coupling to an engine compartment of the vehicle; and
one or more front attachment flanges extending outwardly from the dual intake ducts and including at least one second aperture configured to receive a second fastener for coupling to the engine compartment.

11. The air intake system of claim 9, further comprising a hydrocarbon absorber pad disposed on the bottom wall within the interior chamber.

12. The air intake system of claim 9, wherein the main housing sidewall includes a cutout located between the dual intake ducts, and
wherein the cutout is configured to receive a removable window.

13. The air intake system of claim 9, wherein the air outlet is formed through the bottom wall.

14. The air intake system of claim 1, wherein each of the dual intake ducts comprises:
a top wall;
a bottom wall; and
a pair of opposed sidewalls extending between the top wall and the bottom wall,
wherein the top wall, bottom wall, and opposed sidewalls define a port for providing intake air to the main housing interior chamber.

15. The air intake system of claim 14, wherein the top wall and opposed sidewalls are integrated with the main housing, and
wherein the bottom wall is removably attached to the opposed sidewalls.

16. A kit comprising the air intake system of claim 1, wherein the kit is configured to replace a conventional air intake system of a vehicle.

17. A vehicle, comprising:
an internal combustion engine having a throttle body configured to receive intake air;
an engine compartment with a grille; and
an air intake system, comprising:
a main housing defining an interior chamber configured to receive an air filter;
a cover seated on the main housing to enclose the air filter within the interior chamber;
dual intake ducts fluidly coupled to the interior chamber and configured to provide cold intake air directly from a high pressure zone behind the grille;
an air outlet formed in the main housing and configured to receive intake air that has passed through the air filter; and
an air intake duct having a first end coupled to the air outlet and a second end configured to couple to the throttle body,
wherein the air intake system is configured to provide a short airflow path directly into the engine rather than through a tortuous path.
